(19) United States
(12) Patent Application Publication
(10) Pub. No.: US 2009/0128451 A1
(43) Pub. Date: May 21, 2009

(54) IMAGE DISPLAY DEVICE

(76) Inventor: Kei Tokui, Chiba (JP)

Correspondence Address: BIRCH STEWART KOLASCH & BIRCH, PO BOX 747, FALLS CHURCH, VA, 22040-0747, US

(21) Appl. No.: 12/063,405

(22) PCT Filed: Aug. 10, 2006
(86) PCT No.: PCT/JP2006/315814

§ 371 Date: Feb. 8, 2008

(30) Foreign Application Priority Data
Aug. 25, 2005 (JP) 2005-244270

(51) Int. Cl. G09G 3/20

(52) U.S. Cl. 345/55

(57) ABSTRACT

An image display device is provided which detects light emission intensity of a light source without affecting a display image and can perform a preferable image display by using the detected value even when luminous efficacy of the light source is changed by the temperature change and the change over time. The image display device includes light sources (101-103) with different emission colors and a light modulation element (100) that modulates the light from the light sources depending on image signals, wherein the light modulation element (100) performs image display by reflecting a display image light L₁ used for a display image and an unnecessary light L₂ not used for a display image. The image display device includes an emission intensity detecting portion (108) for detecting the light intensity of the unnecessary light L₂ and a controlling portion (109) for controlling the emission intensity of the light sources (101-103) in accordance with a value detected by the emission intensity detecting portion (108).

### TECHNICAL FIELD

The present invention relates to an image display device and, more particularly, to an image display device that performs the field sequential display providing a plurality of light source of different colors.

### BACKGROUND OF THE INVENTION

Conventionally, an image display device has been proposed that displays a large image by applying light from a light source to a light modulation element and projecting the light modulated to a desired state by the light modulation element onto a screen. LCOS (Liquid Crystal On Silicon) using liquid crystal, DMD (Digital Micromirror Device) including a micromirror array, etc., are used for the light modulation element. Although an ultrahigh pressure mercury lamp is widely used for the light source, the development of image display devices using LED (Light Emitting Diode) is recently promoted.

The image display device using LED is disclosed in Japanese Laid-Open Patent Publication No. 11-32278 (patent document 1), for example. In the document 1, light emitted from LED is applied to DMD, and the modulated light is magnified and projected on a screen through a projection lens. In this device, a color image is displayed by sequentially displaying three images, i.e., a red image, a green image, and a blue image. When an image for red is displayed by the DMD, only the LED emitting red light is caused to emit light; when an image for green is displayed, only the LED emitting green light is caused to emit light; and when an image for blue is displayed, only the LED emitting blue light is caused to emit light. This results in display of a color image having primary colors of red, green, and blue.

Patent Document 1: Japanese Laid-Open Patent Publication No. 11-32278

### DISCLOSURE OF THE INVENTION

### Problems to be Solved by the Invention

However, since the emission intensities of LEDs are changed due to changes over time and changes in temperature, a ratio of light quantities from the red, green, and blue LEDs is changed, which causes changes in the white point and the brightness. The wavelength of the emitted light is also shifted due to currents and voltages supplied to the LEDs. Therefore, if the LED driving condition is changed, the display image is also changed and the image quality is deteriorated.

The present invention was conceived in view of the above situations and it is therefore the object of the present invention to provide an image display device that achieves good quality even when the display condition is changed.

### Means for Solving the Problems

A first image display device according to the present invention comprises a plurality of light sources with different emission colors; a light modulation element that modulates the light from the light sources depending on image signals, wherein, the light modulation element performs to display an image reflecting the display image light used for a display image and unnecessary light not used for the display image; an emission intensity detecting portion that detects the light intensity of the unnecessary light; and a controlling portion that controls the emission intensity of the light sources in accordance with a value detected by the emission intensity detecting portion.

In a second image display device according to the present invention, the light modulation element includes a black image display period when the applied light is considered as the unnecessary light, and the emission intensity detecting portion detects the light intensity of the unnecessary light during the black image display period.

A third image display device according to the present invention comprises a plurality of light sources with different emission colors; a light modulating means that modulates the light from the light sources depending on an image signal; an emission intensity detecting portion that detects light intensity of applied light; a polarizing beam splitter that reflects or transmits light depending on a polarization direction of the incident light, wherein among the light from the light sources, the light with a first polarization direction is applied to the light modulation element through the polarizing beam splitter, among the light from the light sources, the light with a second polarization direction is applied to the emission intensity detecting portion through the polarizing beam splitter, and the emission intensity detecting portion detects the light intensity of the light with the second polarization direction; and a controlling portion that controls the emission intensity of the light sources in accordance with a value detected by the emission intensity detecting portion.

A fourth image display device according to the present invention comprises a plurality of light sources with different emission colors; a light modulation means that modulates the light from the light sources depending on an image signal; an emission intensity detecting portion that detects light intensity of applied light; a diffusion plate that receives the light from the light sources and applies the output light to the light modulation means; and a controlling portion that controls the emission intensity of the light sources in accordance with a value obtained by detecting the light intensity of the reflected light from the diffusion plate.

A fifth image display device according to the present invention comprises a diffusing portion that diffuses and outputs incident light, wherein the emission intensity detecting portion detects the output light from the diffusing portion.

In a sixth image display device according to the present invention, the controlling portion controls the emission intensity of the light sources such that a white point or brightness of a display image can be held constant.

In a seventh image display device according to the present invention, the light sources include a first light source emitting light of a first color and a second light source emitting light of a second color, and during a first period when the light modulation element displays an image of the first color, the first light source and the second light source emit light.

In an eighth image display device according to the present invention, the light modulation element has a second period of displaying an image of the second color, and the controlling portion controls the emission intensity of the second light source such that a sum of quantities of the light emitted during the first period and the light emitted during the second period becomes constant.

A ninth image display device according to the present invention comprises n light sources (n is a positive integer) with different emission colors; a light modulation element that modulates the light from the light sources to perform image display; and a controlling portion that controls the emission intensity of the light sources, wherein the light modulation element sequentially displays images of n colors to display a color image, the light source with the nth emission color emits light during an nth period when the light modulation element displays an image of an nth color, at least one light source emits light among the light sources with first to (n−1)th emission colors during the nth period, the controlling portion controls such that a sum of light quantities emitted during the first to the nth period from the light source with mth emission color (m is a positive integer) emitted during the nth period becomes constant.

A tenth image display device according to the present invention comprises an emission intensity detecting portion that detects a quantity of applied light, wherein the emission intensity detecting portion detects the intensity of light emitted from the light source with the nth emission color and the light source with the mth emission color, and the controlling potion controls a chromaticity point of light applied to the light modulation element during the nth period in accordance with a value detected by the emission intensity detecting portion.

In an eleventh image display device according to the present invention, when receiving a signal to turn off the power of the image display device, the light modulation element performs black image display to make the applied light the unnecessary light, and the power of the image display device is turned off after the light intensity of the unnecessary light is detected.

In a twelfth image display device according to the present invention, the value detected by the emission intensity detecting portion is stored in the controlling portion.

In a thirteenth image display device according to the present invention, when a signal to turn on the power of the image display device is received, the value stored in the controlling portion is used to control the emission intensity of the light sources.

In a fourteenth image display device according to the present invention, if a target value of the emission intensity of the light sources is received when the image display device displays an image, the light modulation element performs black image display to make the applied light the unnecessary light, and the light intensity of the unnecessary light is detected to control the emission intensity of the light sources.

In a fifteenth image display device according to the present invention, the emission intensity detecting portion is disposed such that a light detection surface of the emission intensity detecting portion reflects the incident light on the light detection surface to a light absorber that absorbs incident light.

In a sixteenth image display device according to the present invention, the controlling portion stores the value detected by the emission intensity detecting portion in accordance with time after the power of the image display device is turned on or a value of temperature of the light sources.

### EFFECT OF THE INVENTION

According to an image display device of the present invention, in an image display device including a plurality of light sources with different emission colors to perform the field sequential display, the emission intensity of light-source can be known by detecting the light intensity of light not used for a display image among the light emitted from a light source without causing deterioration in the display image.

According to the image display device of the present invention, if a light modulation element is a DMD including a micromirror array, a quantity of light applied to the DMD can accurately be detected by detecting the light intensity of unnecessary light by an emission intensity detecting portion during a black image display period when it makes the light applied to the DMD the unnecessary light.

According to the image display device of the present invention, an average value can be detected for the light applied to the light modulation element and the light intensity can be detected in consideration of the entire display image by making the light to be detected by the emission intensity detecting portion diffused light.

According to the image display device of the present invention, the good-quality image display can be achieved by controlling the white point or the brightness with a value detected by the emission intensity detecting portion.

According to the image display device of the present invention, the primary color point of the display image can be controlled and the good-quality image display can be achieved by emitting light from not only a light source emitting nth-color light but also a light source emitting mth-color light during an image display period of the nth color.

According to the image display device of the present invention, if the primary color point of the display image is controlled, the white point and the brightness can also be controlled by controlling the light source such that a quantity of light emitted from first to nth periods is held constant.

According to the image display device of the present invention, since the light intensity is detected before turning off the power and it does not need to detect the emission intensity during the image display period, it does not need to provide the black image display period during the image display and a bright image can be acquired. If the response of the emission intensity of the light source is not sufficient, the light source can be controlled.

According to the image display device of the present invention, since a light detection surface of the emission intensity detecting portion is disposed such that the light applied to a photodetecting portion is reflected to a light absorber, a high-quality image can be displayed with the stray light reduced.

### BRIEF DESCRIPTION OF THE DRAWINGS

FIG. 1 is a view of a schematic configuration of a first embodiment of the present invention.

FIG. 2 is a view of an example of the LED emission and the light sensor detection timing in the first embodiment.

FIG. 3 is a view of an example of the LED emission and the light sensor detection timing in the first embodiment.

FIG. 4 is a view of an example of the LED emission and the light sensor detection timing in the first embodiment.

FIG. 5 is a view of an example of the LED emission and the light sensor detection timing in the first embodiment.

FIG. 6 is a view of disposition of the light sensor in the first embodiment.

FIG. 7 is a view of another disposition of the light sensor in the first embodiment.

FIG. 8 is a view of a schematic configuration of a second embodiment of the present invention.

FIG. 9 is a view of an example of the LED emission and the light sensor detection timing in the second embodiment.

FIG. 10 is a view of a schematic configuration of a third embodiment of the present invention.

FIG. 11 is a view of an example of the LED emission and the light sensor detection timing in the third embodiment.

FIG. 12 is a view of an example of the response characteristics of the LED emission intensity and the output response characteristics of the light sensor in the fourth embodiment.

### EXPLANATIONS OF REFERENCE NUMERALS

100 . . . DMD; 101 . . . R-LED; 102 . . . C-LED; 103 . . . B-LED; 104, 105 . . . dichroic mirror; 106 . . . reflection mirror; 107 . . . lens; 108 . . . light sensor; 109 . . . controlling portion; 110 . . . prism; 111 . . . polarizing beam splitter; 112 . . . LCOS; 113 . . . diffusion sheet; 114 . . . light absorber; 115 . . . diffusion plate; and 116 . . . liquid crystal panel.

### PREFERRED EMBODIMENTS OF THE INVENTION

The present invention will hereinafter be described with reference to the drawings. Configurations in the figures are exaggeratingly illustrated to facilitate the understanding and are different from those having actual intervals and sizes.

### First Embodiment

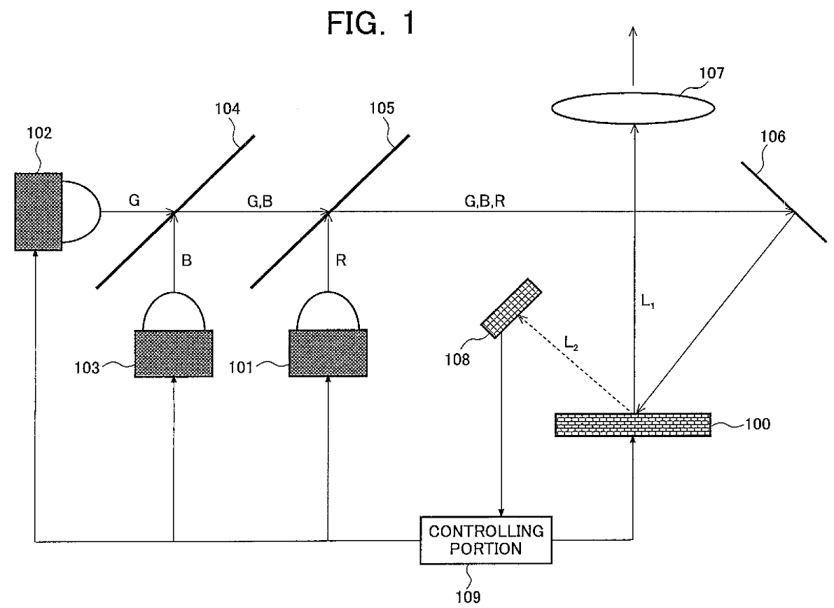

FIG. 1 is a view of a schematic configuration of an image display device of a first embodiment of the present invention. This embodiment uses an R-LED 101 that emits red light, a G-LED 102 that emits green light, and a B-LED 103 that emits blue light as light sources and uses a DMD 100 as a light modulation element. The controlling portion 109 turns on the light sources corresponding to an image displayed by the DMD 100.

A dichroic mirror 104 has characteristics of allowing the green light to pass through and reflecting the blue light. Therefore, when the light emitted from the G-LED 102 is the incident light on the dichroic mirror 104, the light is transmitted without changing the traveling direction. When the light emitted from the B-LED 103 is the incident light on the dichroic mirror 104, the light is reflected by the dichroic mirror 104 and the traveling direction is changed. This enables the light emitted from the G-LED 102 and the B-LED 103 to travel in the same direction and to be the incident light on a dichroic mirror 105.

The dichroic mirror 105 has characteristics of allowing the green and blue light to pass through and reflecting the red light. Therefore, when the green and blue light from the dichroic mirror 104 are the incident light on the dichroic mirror 105, the light is transmitted without changing the traveling direction. When the light emitted from the R-LED 101 is the incident light on the dichroic mirror 105, the light is reflected by the dichroic mirror 105 and the traveling direction is changed. That is, the dichroic mirror 105 can cause the light emitted from the R-LED 101, the G-LED 102, and the B-LED 103 to travel in the same direction.

The red, green, and blue light having substantially the same light path due to the dichroic mirrors 104 and 105 are applied to the DMD 100 by an optical member 106 such as a mirror and a lens. The DMD 100 represents a display image with a reflected light L₁ of a polarizing mirror array, and the modulated light comes in a projection lens 107 and is magnified and displayed on a screen. A light L₂ not necessary for the image display is reflected as OFF-light to a direction of a light sensor 108. The controlling portion 109 includes a microcomputer, a LED driver, a DMD driver, etc., and activates the LEDs corresponding to the display image of the DMD 100.

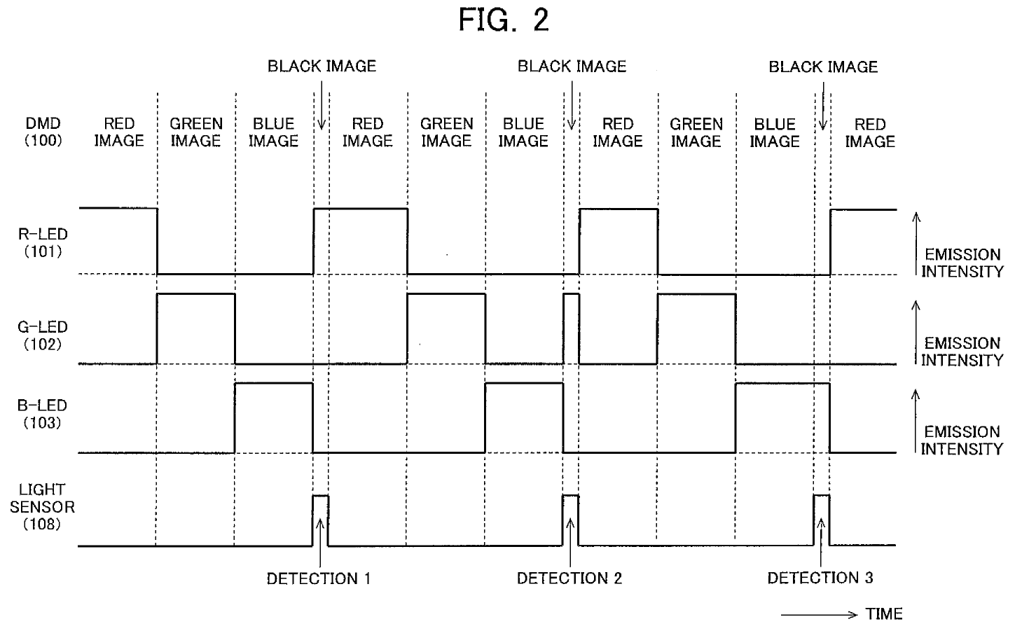

FIG. 2 shows an example of the LED emission timing. The controlling portion 109 activates the R-LED 101 emitting the red light when the DMD 100 displays a red image, activates the G-LED 102 emitting the green light when the DMD 100 displays a green image, and activates the B-LED 103 emitting the blue light when the DMD 100 displays a blue image.

In this embodiment, a period of performing black display by the DMD 100 is provided in one cycle of red, green, and blue. This is a period of detecting the emission intensity of the R-LED 101, the G-LED 102, or the B-LED 103 by the light sensor 108. Although the OFF-light can be detected even when the DMD 100 is displaying an image, the OFF-light quantity varies and the accurate emission intensity cannot be detected unless the same image is displayed each time during the image display. Therefore, the black image display period may be provided to reflect the light applied to the DMD 100 as substantially the same quantity of the OFF-light. Since the light from the LEDs make no contribution to the display during the period of performing the black image display, a brighter image can be acquired by performing one black image display per cycle of displaying the red, green, and blue images as compared to the case of performing the black image display each time after one color image is displayed.

In FIG. 2, during a period of performing detection 1, the black image is displayed and only the R-LED 101 is caused to emit light with a voltage and a current for the red image display period. Therefore, only the red light is applied to the light sensor 108 as the OFF-light, and the emission intensity of the R-LED 101 can be detected. During a period of performing detection 2, the black image is displayed and only the G-LED 102 is caused to emit light with a voltage and a current for the green image display period. Therefore, only the green light is applied to the light sensor 108 as the OFF-light, and the emission intensity of the G-LED 102 can be detected. During a period of performing detection 3, the black image is displayed and only the B-LED 103 is caused to emit light with a voltage and a current for the blue image display period. Therefore, only the blue light is applied to the light sensor 108 as the OFFlight, and the emission intensity of the B-LED 103 can be detected. Although not shown here, it is possible to improve the accuracy of the emission intensity control with the information on the brightness of the dark state obtained by the detection of the emission intensity of the LEDs performed with all the LEDs turned off during the black image display period.

The emission intensities of the LEDs are detected by the light sensor 108 and transmitted to the controlling portion 109. A Si-photodiode, etc., may be used for the light sensor 108. The brightness and the white point are controlled by comparing the values of the transmitted emission intensity with the data stored in the controlling portion 109. For example, if the emission intensity ratio of red, green, and blue must be 1:2:1 to acquire a desired white point, the emission intensity of the LEDs are controlled such that the emission intensity ratio becomes 1:2:1. If the initial values of the emission intensity of the LEDs are small, the ratio may be achieved by increasing the emission intensity, and if the initial values of the emission intensity of the LEDs are large, the ratio may be achieved by reducing the emission intensity. If an attempt is made to acquire the larger emission intensity when the initial value of the emission intensity is large, this attempt is limited due to the maximum rating of the LED. If an attempt is made to acquire the smaller emission intensity when the initial value of the emission intensity is small, this attempt is limited because the LED is turned off.

The brightness is adjusted while maintaining the emission intensity ratio achieved for the white point. That is, if the shortage of brightness detected by the light sensor 108 is 10%, the brightness can be adjusted while maintaining the white point by increasing the emission intensity of each LED by 10%.

The white point and the brightness can be held constant or can be set to a certain value by performing the feedback control of the LED emission intensity by the controlling portion 109 in this way. The method of performing the feedback control is not limited to the above method and can be achieved by employing various methods and, for example, the control can be performed by gradually adjusting the white point and brightness closer to the target value.

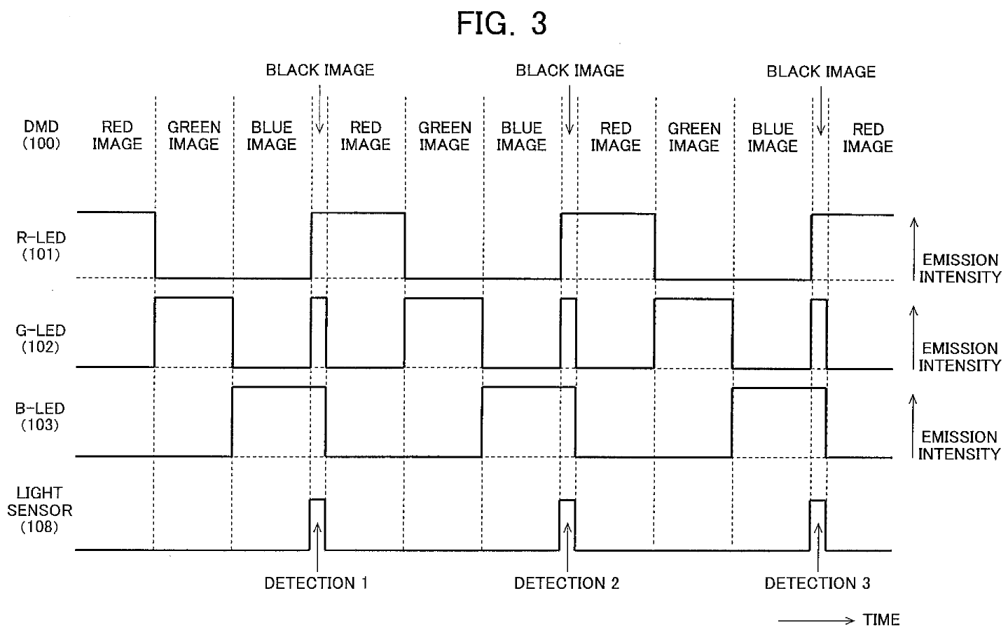

If the light sensor 108 includes filters corresponding to red, green, and blue, the detection can be performed using a method shown in FIG. 3. That is, the R-LED 101, the G-LED 102, and the B-LED 103 are caused to emit light during the period of displaying the black image and detecting it by the light sensor 108. The light of each color is applied to the light sensor 108 and the light sensor provided with the red filter can detect the emission intensity of the R-LED 101 since the red light passes through the filter and reaches a sensing portion. Similarly, the light sensor provided with the green filter can detect the emission intensity of the G-LED 102 since the green light passes through the filter and reaches the sensing portion, and the light sensor provided with the blue filter can detect the emission intensity of the B-LED 103 since the blue light passes through the filter and reaches the sensing portion. This increases the frequency of detection and the accuracy is improved in the feedback control of the white point and the brightness. The detecting method of FIG. 2 can also be applied in the case that the light sensor 108 includes the filters corresponding to red, green, and blue.

A method of controlling the primary color point will then be described. In the case of performing the color display, if the primary color point varies, the quality of gradation display is deteriorated in the image display in addition to changes in a color reproduction range. Since the LED emission wavelength varies due to temperature and the applied current, the higher-quality image display can be achieved by maintaining the primary color point in various environments.

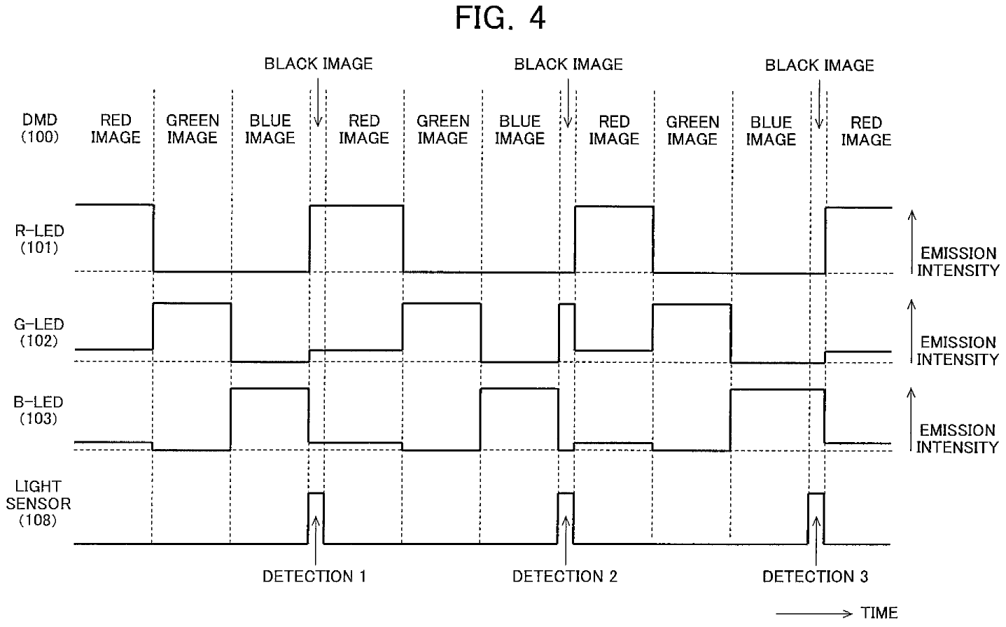

The control of the primary color point is performed at the LED emission timing shown in FIG. 4, for example. FIG. 4 shows the case that only the red primary color point is adjusted. When the DMD 100 displays the red image, the R-LED 101 is caused to mainly emit light, and the G-LED 102 and the B-LED 103 are also caused to emit light. This enables the adjustment of the primary color point. That is, three stimulus values Xr, Yr, Zr of the light applied for the red image display are represented by the equations 1 to 3 by using three stimulus values Xrr, Yrr, Zrr of the R-LED 101, three stimulus values Xrg, Yrg, Zrg of the G-LED 102, and three stimulus values Xrb, Yrb, Zrb of the B-LED 103.

Xr=Xrr+Xrg+Xrb (Eq. 1)

Yr=Yrr+Yrg+Yrb (Eq. 2)

Zr=Zrr+Zrg+Zrb (Eq. 3)

Therefore, if Xrr, Yrr, and Zrr are changed, Xrg, Yrg, Zrg, Xrb, Yrb, and Zrb can be changed by changing the emission intensity of the G-LED 102 and the B-LED 103 to maintain X, Y, and Z, and the red primary color point can be controlled. In a similar method, the primary color point can be controlled for green and blue respectively, by mainly emitting light from the G-LED 102 and also emitting light from the R-LED 101 and the B-LED 103 when the DMD 100 displays the green image, and by mainly emitting light from the B-LED 103 and also emitting light from the R-LED 101 and the G-LED 102 when the DMD 100 displays the blue image.

Since the light is emitted from not only the R-LED 101 but also the G-LED 102 and the B-LED 103 when controlling the red primary color point, if the G-LED 102 and the B-LED 103 emit light for the green image display and the blue image display with the same emission intensity as that before adjusting the red primary color point, the white point and the luminance are changed. The emission intensity of the G-LED 102 at the time of the green image display is reduced by the extent of the emission intensity of the G-LED 102 for the red image display. Similarly, the emission intensity of the B-LED 103 at the time of the blue image display is reduced by the extent of the emission intensity of the B-LED 103 for the red image display. Therefore, a relationship between three green stimulus values Xgg, Ygg, Zgg and three blue stimulus values Xbb, Ybb, Zbb before reducing the emission intensity and three green stimulus values Xg, Yg, Zg and three blue stimulus values Xb, Yb, Zb after reducing the emission intensity is represented by the equations 4 to 9.

Xg=Xgg−Xrg (Eq. 4)

Yg=Ygg−Yrg (Eq. 5)

Zg=Zgg−Zrg (Eq. 6)

Xb=Xbb−Xrb (Eq. 7)

Yb=Ybb−Yrb (Eq. 8)

Zb=Zbb−Zrb (Eq. 9)

When the emission intensities of the LEDs are controlled, three stimulus values Xw, Yw, Zw of the white point are represented by the equations 10 to 12.

$$\begin{matrix}\begin{matrix}Xw = Xr + Xg + Xb \\ = ( Xrr + Xrg + Xrb ) + ( Xgg - Xrg ) + ( Xbb - Xrb ) \\ = Xrr + Xgg + Xbb\end{matrix} & ( Eq . 10 ) \\ \begin{matrix}Yw = Yr + Yg + Yb \\ = ( Yrr + Yrg + Yrb ) + ( Ygg - Yrg ) + ( Ybb - Yrb ) \\ = Yrr + Ygg + Ybb\end{matrix} & ( Eq . 11 ) \\ \begin{matrix}Zw = Zr + Zg + Zb \\ = ( Zrr + Zrg + Zrb ) + ( Zbb - Zrg ) + ( Zbb - Zrb ) \\ = Zrr + Zgg + Zbb\end{matrix} & ( Eq . 12 )\end{matrix}$$

Therefore, the three stimulus values of the white point after the control becomes identical to the three stimulus values of the white point before the control, and the white point and the brightness are maintained. That is, the primary color point can be controlled while maintaining the white point and the brightness by making the G-LED 102 and the B-LED 103 emit light in addition to the R-LED 101 during the period of the red image display and by subtracting the quantity of light emitted during the period of the red image display from the quantity of light emitted by the G-LED 102 during the period of the green image display and from the quantity of light emitted by the B-LED 103 during the period of the blue image display.

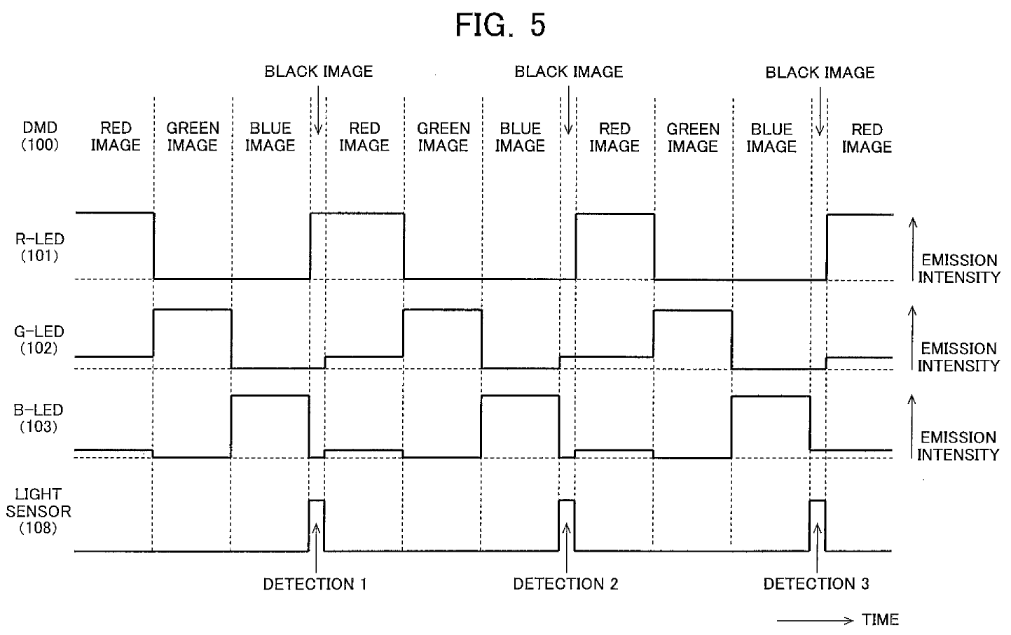

Although the case of performing the primary color point control only for red has been described above, the same method is applicable to the primary color point control for green, the primary color point control for blue, and the primary color point control for a plurality of colors. With regard to the detection by the light sensor 108 for the primary color point control, the same effect can also be acquired using a method, which is shown in FIG. 5, of detecting the emission intensity of the R-LED 101 of the red image display period during the period of performing the detection 1, detecting the emission intensity of the G-LED 102 of the red image display period during the period of performing the detection 2, and detecting the emission intensity of the B-LED 103 of the red image display period during the period of performing the detection 3.

The primary color point can be controlled not only to have no changes due to the wavelength shift of the LEDs but also to have a desired value. For example, the primary color point can be conformed with the display corresponding to a standard such as NTSC or sRGB indicating a chromaticity point or can be set within a color reproduction range according to viewer's preference.

Although the image display device using the DMD has been described in this embodiment, since a reflected light quantity of the micromirror is controlled according to the time within a certain period in the gradation representing method of the DMD, if the control of the LED emission intensity is performed according to the emission time, the gradation cannot sufficiently represented. Therefore, it is desirable for the current control to be able to perform the emission intensity control while maintaining the constant LED emission time. If the emission intensity is controlled according to the LED emission time, the control can be achieved by increasing and decreasing the red, green, and blue image display periods of the DMD in accordance with the LED emission time.

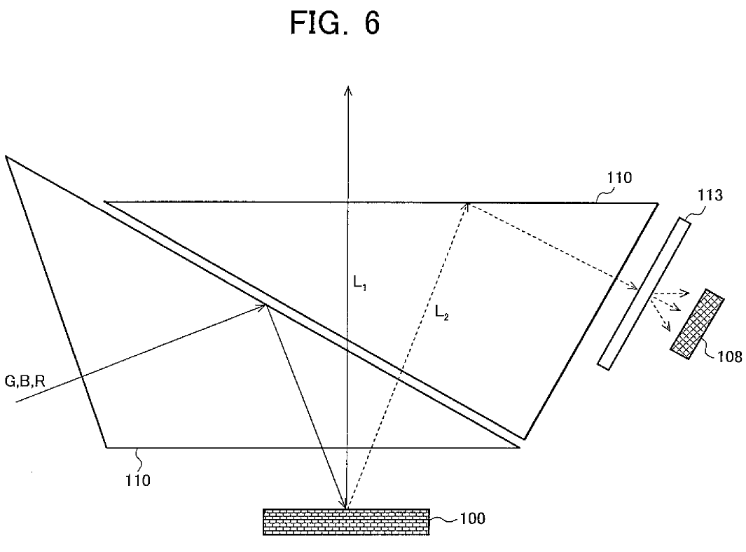

Any one of the white point, the brightness, and the primary color point can be controlled better by performing average control over the entire display image than performing control over some portion of the display image. For example, in an optical system using the DMD and the TIR prism, the OFF-light is detected at a position shown in FIG. 6 by the light sensor 108. In this case, it does not need to condense the light with a lens, etc., and it is recommended to detect the light coming from the entire DMD 100 display surface propagated through a prism 110. A diffusion sheet 113 may be disposed between the prism 110 and the light sensor 108 to increase the degree of diffusion.

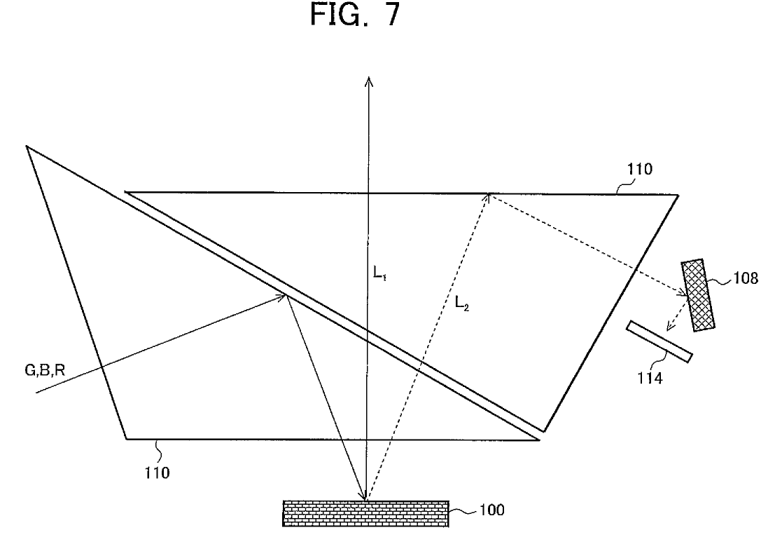

The incident light on the light sensor is reflected from the light sensor and projected as stray light on the projection lens and it may cause the image quality to deteriorate. The stray light can be reduced by disposing the detection surface of the light sensor 108 with a tilt from the traveling direction of the OFF-light as shown in FIG. 7, namely, by reflecting the light to a direction different from those of the DMD and the projection lens with the incident angle on the light sensor 108 being not perpendicular. It is preferable to dispose the light sensor with an angle set such that the reflected light from the sensor is directed toward a light absorber 114 that absorbs light. It is also preferable to dispose a light absorber around the light sensor 108 to absorb unnecessary light.

As described above, according to the image display device of this embodiment, the good-quality image display is achieved by controlling the white point and the brightness with the detection of the LED emission intensity by the light sensor 108, and the light applied to the DMD can uniformly be detected by providing the black image display period during displaying an image and detecting the LED emission intensity from the OFF-light of the DMD. A brighter image can be acquired by performing detection once per cycle to minimize the time not attributable to an image display. The primary color point can also be controlled and even if the LED wavelength is shifted, the primary color point can be maintained to perform the good-quality image display. The entire display image can be controlled by means of the detection of the light intensity over the entire display surface which is performed by diffusing the OFF-light from the DMD and detecting it by the light sensor.

### Second Embodiment

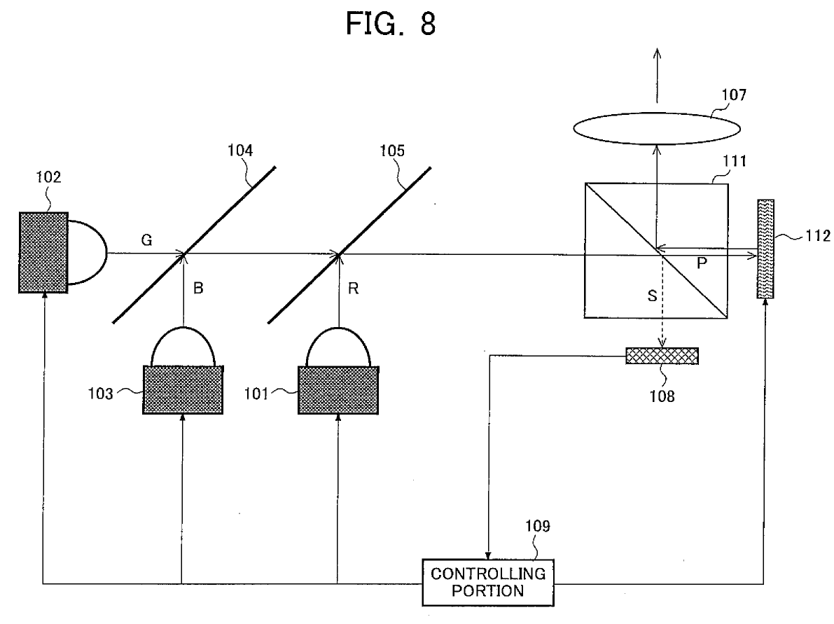

FIG. 8 is a view of a schematic configuration of an image display device of a second embodiment of the present invention.

The second embodiment of the present invention will hereinafter be described in detail with reference to the drawings. However, the same reference numerals are given to portions having the same functions as those in the first embodiment.

With regard to the lights emitted from the R-LED 101, the G-LED 102, and the B-LED 103, the dichroic mirrors 104 and 105 can cause the lights emitted from the R-LED 101, the G-LED 102, and the B-LED 103 to travel in the same direction similarly as shown in the first embodiment.

The lights emitted from the LEDs are led to a polarizing beam splitter 111. Among the lights from the LEDs, the P-polarized light is transmitted and the S-polarized light is reflected. The transmitted light is led to an LCOS 112 and modulated to represent the image gradations. The modulated light is led to the polarizing beam splitter 111 again, and the light used for the image display is reflected to be magnified and displayed by the projection lens 107. The light not used for the image display is transmitted through the polarizing beam splitter 111 and returned to the direction of the LEDs.

Among the lights emitted by the LEDs and led to the polarizing beam splitter 111, the S-polarized light is reflected without making contribution to the image display. The white point, the brightness, and the primary color point can be controlled by detecting the light intensity of the reflected light by the light sensor 108. Therefore, the efficiency is improved since the LED emission intensity is detected by making use of the light which was not used before.

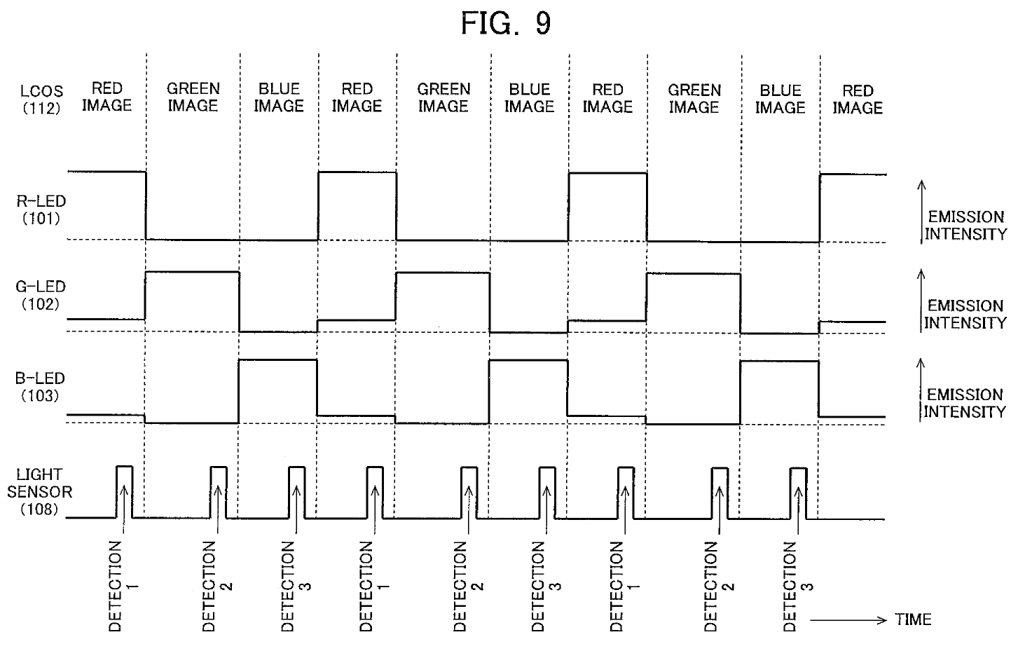

The controlling method of the white point, the brightness, and the primary color point may be the same as that employed in the first embodiment. The image display of the LCOS 112, the LED emission, and the detection timing of the light sensor 108 may be controlled as shown in FIG. 9. FIG. 9 is a view showing that the white point, the brightness, and the red primary color point are controlled.

When the LCOS 112 displays the red image, the R-LED 101 is cased to mainly emit light to perform the primary color control with the G-LED 102 and the B-LED 103. When the LCOS 112 displays the green image, the G-LED 102 is cased to emit light and when the LCOS 112 displays the blue image, the B-LED is cased to emit light. The light sensor 108 performs detection 1 when the red image is displayed to detect the intensity of light used for the red image display, performs detection 2 when the green image is displayed to detect the intensity of light used for the green image display, and performs detection 3 when the blue image is displayed to detect the intensity of light used for the blue image display. This enables the detection of the intensities of lights used for the color displays and the control of the white point, the brightness, and the primary color point.

In this case, a polarization conversion element, etc., may be used to improve the usage efficiency of lights from the LEDs by leading the lights to that element before the lights are led to the polarizing beam splitter 111. However, if the polarization directions of the lights from the LEDs are aligned by the polarization conversion element, all the polarization directions of the incident lights cannot be made identical. Therefore, if the polarization conversion element is disposed to lead the P-polarized light to the polarizing beam splitter in this embodiment, the S-polarized light still exists and the light sensor 108 can detect the emission intensity of the LED.

Although the emission intensity of the LED is detected by the light sensor 108 for every color image display as shown in FIG. 5 in this embodiment, the white point, the brightness, and the primary color point can be controlled by performing the detection every several times. For example, the frequency of detection of the emission intensity may be increased when turning on the power, etc., because change of temperature, etc., is large for a while after that moment, and the frequency of detection may be reduced when the steady state is achieved.

Although one LCOS is used as the light modulation element in this embodiment, the present invention is applicable in the case of using a plurality of LCOSs such as two or three LCOSs.

As described above, according to the image display device of this embodiment, the white point and the brightness are controlled to achieve the good-quality image display by detecting the LED emission intensity with the light sensor, and the light applied to the LCOS can be detected without affecting the image display by detecting the LED emission intensity using the polarized light not used by the polarizing beam splitter. The primary color point can also be controlled and even if the LED wavelength is shifted, the primary color point can be maintained to perform the good-quality image display.

### Third Embodiment

A third embodiment of the present invention will hereinafter be described in detail with reference to the drawings. However, the same reference numerals are given to portions having the same functions as the first embodiment.

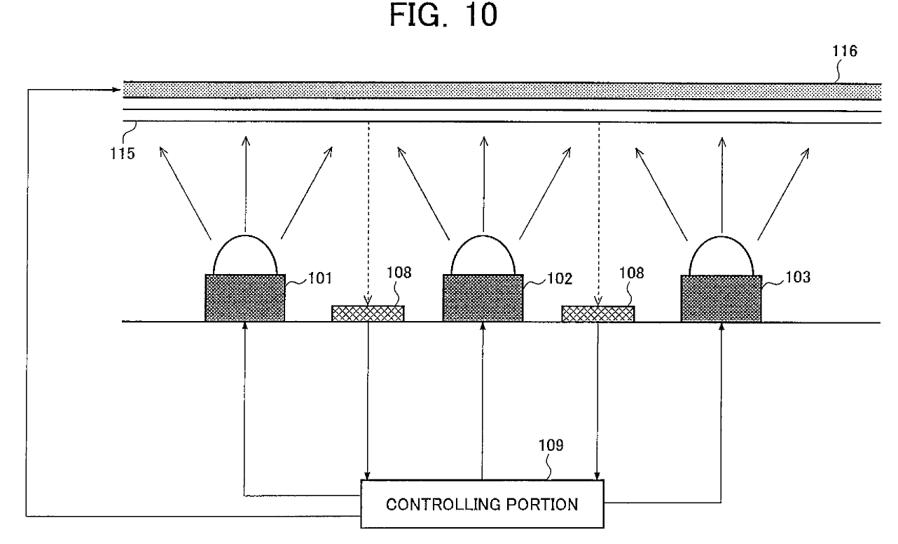

FIG. 10 is a view of a schematic configuration of an image display device of a third embodiment of the present invention. In this embodiment, a liquid crystal display device includes a liquid crystal panel 116, and the lights emitted from the R-LED 101, the G-LED 102, and the B-LED 103 are incident on a diffusion plate 115 and go out as the diffused light to be applied to the liquid crystal panel 116. The liquid crystal panel 116 modulates the incident light to display a color image using the red image display, the blue image display, and the green image display in the same manner as the LCOS 112 does in the second embodiment. An optical sheet such as a diffusion polarization sheet or a prism sheet may be disposed between the diffusion plate 115 and the liquid crystal panel 116. Although one LED is two-dimensionally disposed for each of red, green, and blue, the LEDs may three-dimensionally be disposed or a plurality of LEDs may be disposed for each color.

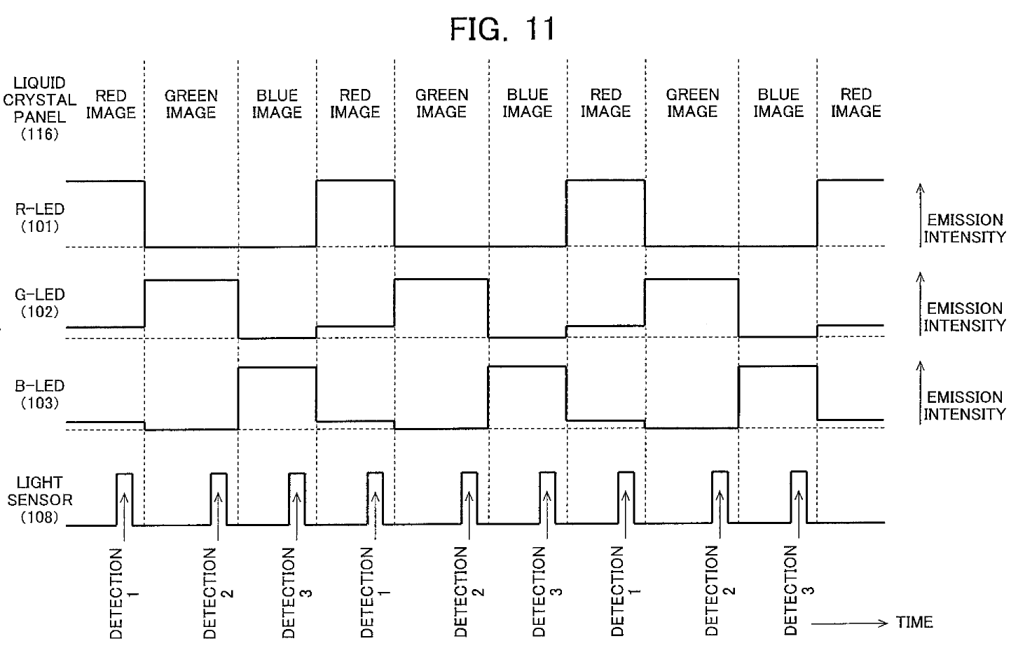

Although the lights emitted from the LEDs are incident on the diffusion plate 115, a portion of the lights is reflected from the surface or the inside of the diffusion plate 115. The intensity of this light can be detected by the light sensor 108 to detect the light intensities of the R-LED 101, the C-LED 102, and the B-LED 103. The liquid crystal panel 116, the R-LED 101, the G-LED 102, the B-LED 103, and the light sensor 108 can be controlled using a method shown in FIG. 11. The LCOS 112 of the second embodiment is replaced with the liquid crystal panel in this case, and the second embodiment can be applied as the controlling method. The same method as that of the first embodiment can be applied as the method of controlling the white point, the brightness, and the primary color point.

In this embodiment, the light sensors 108 are located at two positions. This is because the emission intensity of the whole of a plurality of LEDs cannot uniformly be detected since the light incident on the light sensor 108 is strongly affected by the emission intensity of the LED disposed in the vicinity of the light sensor 108. Especially in the case of the large liquid crystal display device, since the backlight is also large and temperature irregularities are generated, an amount of change in the LED emission intensity varies in each area. Therefore, the accuracy of the control of the white point, the brightness, and the primary color point can be improved by disposing a plurality of the light sensors 108 to detect the emission intensity of each area. If the backlight is small and the general control is performed using the emission intensity of a certain area, the effect of the present invention may be acquired by detecting the LED emission intensity using the signal light sensor 108.

Although the liquid crystal display device having the direct backlight has been described in the embodiment, this is applicable to the liquid crystal display device having the side-edge backlight including an optical waveguide.

As described above, according to the image display device of this embodiment, the white point and the brightness are controlled to achieve the good-quality image display by detecting the LED emission intensity with the light sensor, and the light applied to the liquid crystal panel can be detected without affecting the image display by detecting the LED emission intensity from the diffusion panel. The primary color point can also be controlled and even if the LED wavelength is shifted, the primary color point can be maintained to perform the good-quality image display.

### Fourth Embodiment

A fourth embodiment of the present invention will hereinafter be described in detail with reference to the drawings. However, the same reference numerals are given to portions having the same functions as the first embodiment.

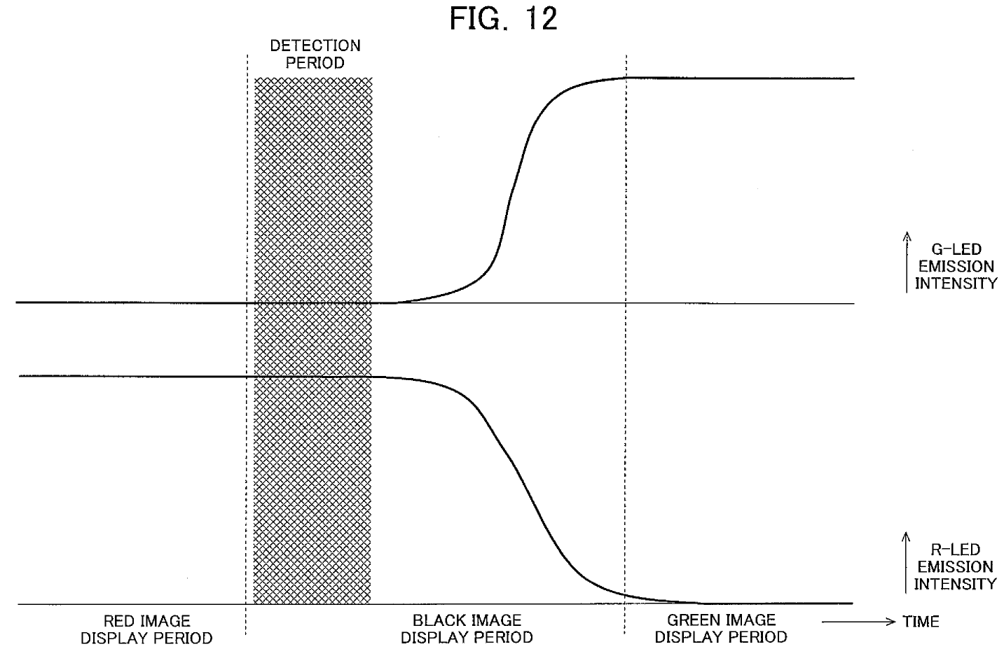

In this embodiment, the feedback control is performed to control the LED emission intensity before turning off the power of the image display device. In the image display device using the DMD as the light modulation element as shown in the first embodiment, if the feedback control is performed by detecting the OFF-light during the image display period, the black image display must be provided in the image display period. Therefore, the black display period should be as short as possible to acquire a brighter image. To perform highly accurate feedback control, the detection must be performed while the LED emission intensity is stable. FIG. 12 shows the black image display period when the red image is switched to the green image. Since an LED driver has response characteristics and since the mixture of color with different color images must be decreased to prevent the deterioration of image quality from occurring and the emission luminance must be detected in the stable light intensity, the length of the black display period is mainly determined by the characteristics of the LED driver. If the LED driver characteristics are not sufficient, a longer black display period must be provided. The method of this embodiment is especially applicable when the LED driver characteristics are not sufficient.

In this embodiment, the feedback control is performed when a signal is transferred to turn off the power of the image display device. In the feedback control, the OFF-light is detected with the DMD displaying black. However, since the power is turned off, no image display is needed and the DMD can constantly be put into the black display period. That is, if the LED driver characteristics are not sufficient, the detection period for the feedback control can be provided by extending the black display period. The emission intensity of each color LED is controlled in conformity with the target white point stored in the controlling portion. The emission intensity of each color LED having the white point or brightness substantially identical to the target value is stored in the controlling portion, etc. The stored value may be an emission intensity value, a current value, a voltage value, etc. After the values of the LEDs are stored, the power of the image display device is completely cut off. When the power of the image display device is turned on, the LED emission intensity is controlled with the use of the value stored in the controlling portion at the previous time of turning off the power. When the power is turned off, the feedback control is performed. Repeating this control can reduce changes in the white point caused by the changes in the LED emission intensity due to changes over time and changes in temperature.

Since the temperature is not stabilized if the period between turning on and off the power is short, the feedback control may not be performed with a correct value. Therefore, it is preferred to perform the control such that the feedback control is performed to store the value after it is detected that the LED temperature is constant by setting conditions for acquiring the feedback control value with the use of techniques such as counting the time of turning on the power or detecting the LED temperature with a thermistor.

With the above method, if the LED driver characteristics are not sufficient, the feedback control can be achieved without providing the longer black display period during the image display period. Since the black display period does not need to be provided in the image display period, the brighter image can be displayed even if the feedback control is performed.

Although the feedback control is performed at the time of turning off the power in this embodiment, the same effect can be acquired by providing a period of performing calibration in accordance with input from a user to perform the feedback control using this period as the black image display.

1-16. (canceled)

17. An image display device comprising:
a plurality of light sources with different emission colors;
a light modulation element that modulates the light from the light sources depending on image signals;
an emission intensity detecting portion that detects the light intensity of the light emitted from the light sources; and
a controlling portion that controls the emission intensity of the light sources, wherein
a value detected by the emission intensity detecting portion is stored in the controlling portion when a signal for turning off the power is received, and
the controlling portion controls the emission intensity of the light sources to come to the value detected by the emission intensity detecting portion when a signal for turning on the power is received.

18. The image display device as defined in claim 17, wherein
the light modulation element performs an image display reflecting the display image light used for a display image and unnecessary light not used for the display image,
the light modulation element performs a black image display when a signal for turning off the power is received,
the emission intensity detecting portion detects the intensity of the light from the light sources at the time of the black image display, and
the light intensity detected at the time of the black image display is stored in the controlling portion.

19. The image display device as defined in claim 17, wherein the controlling portion stores a value detected by the emission intensity detecting portion in accordance with time after the power is turned on or the temperature of the light sources.

20. The image display device as defined in claim 17, wherein the controlling portion controls the emission intensity of the light sources such that a white point or brightness of a display image can be held constant.

21. The image display device as defined in claim 17, wherein if a target value of the emission intensity of the light sources is received when the image display device displays an image, the light modulation element performs black image display to make the applied light the unnecessary light, and wherein the light intensity of the unnecessary light is detected to control the emission intensity of the tight sources.

22. The image display device as defined in claim 18, wherein the controlling portion stores a value detected by the emission intensity detecting portion in accordance with lime after the power is turned on or the temperature of the light sources.

23. The image display device as defined in claim 18, wherein the controlling portion controls the emission intensity of the light sources such that a white point or brightness of a display image can be held constant.
